(19) United States
(12) Patent Application Publication
(10) Pub. No.: US 2013/0248443 A1
(43) Pub. Date: Sep. 26, 2013

(54) SELENIUM RECOVERY FROM BIOREACTOR SLUDGE

(71) Applicants: Jie Guan, Torrance, CA (US); Oijia Fu, Shanghai (CN); Hong Zhou, Pudong (CN); Yan Jin, Shanghai (CN); Weiqing Xu, Shanghai (CN); Jungang Zhang, Shanghai (CN); Yanping Liu, Shanghai (CN); Minggang She, Shanghai (CN)

(72) Inventors: Jie Guan, Torrance, CA (US); Oijia Fu, Shanghai (CN); Hong Zhou, Pudong (CN); Yan Jin, Shanghai (CN); Weiqing Xu, Shanghai (CN); Jungang Zhang, Shanghai (CN); Yanping Liu, Shanghai (CN); Minggang She, Shanghai (CN)

(21) Appl. No.: 13/255,007

(22) PCT Filed: Dec. 17, 2010
(86) PCT No.: PCT/CN10/02069

§ 371 Date: Sep. 6, 2011

(51) Int. Cl. C02F 11/00

(52) U.S. Cl. CPC C02F 11/004
USPC 210/609; 423/510

(57) ABSTRACT

Wastewater, for example flue gas desulphurization blowdown water, containing soluble selenium is treated in a bioreactor. Microorganisms in the reactor reduce the selenium to elemental selenium, which is insoluble. The elemental selenium is discharged from the reactor in waste sludge also comprising biomass and other suspended solids. Non-microbial suspended solids are removed by way of acid dissolution followed by de-watering. The remaining sludge is burned at a temperature below the selenium oxidation temperature to remove biomass while leaving selenium particles behind.

### FIELD

This specification relates to wastewater treatment to remove selenium and to the recovery of selenium from wastewater.

### BACKGROUND

The following paragraphs are not an admission that any of the information below is common general knowledge or citable as prior art.

Selenium is a trace element essential for human health. Selenium is also a precious non-metal with several useful properties. For example, selenium has photovoltaic and conductive properties making it useful in photovoltaic and electronic products. Selenium is also used as a pigment in glass and in vitamin supplements and fertilizer.

However, selenium also becomes toxic at very low concentrations. Selenium accumulates in the bodies of plants and fish that live in selenium-contaminated water and in the bodies of wildlife and people that eat those plants and fish. In people, elevated selenium concentrations may cause neurological damage and hair and nail loss.

Selenium may be present in soluble forms (selenate and selenite) in wastewater produced in various industrial or agricultural operations. For example, selenium is often present in flue gas desulphurization blowdown water produced in coal fired power plants. Selenium can also be present in some oil refining and mining wastes. Discharge limits for selenium may be set at between 10 parts per billion (ppb) and 50 ppb.

International Publication Number WO 2007/012181 describes a biological reactor for removing selenium from wastewater. Selenium removing reactors are sold by the General Electric Company, GE Water and Process Technologies, under the ABMet trade mark. In these reactors, a fixed media bed supports a biofilm of selenium reducing organisms. The organisms reduce selenate and selenite in the wasterwater to elemental selenium, which precipitates from the wastewater. The selenium is retained in the reactor until it is removed in a waste sludge by a periodic flushing operation.

### SUMMARY

The following summary is intended to introduce the reader to the detailed description to follow and not to limit or define any claimed invention.

The sludge removed from a selenium bioreactor contains elemental selenium and may be classified as a toxic waste. The sludge must therefore be stored or disposed of to prevent selenium leaching into the environment. The cost of storing or disposing of the sludge is significant. On the other hand, the selenium in the sludge is a valuable commodity. Accordingly, recovering the selenium from the sludge produces a useable product and reduces a waste handling and environmental problem.

In a process described herein, a sludge containing elemental selenium, microorganism and other solids, for example minerals, is treated to recover the selenium. The sludge is mixed with an acid to dissolve some of the solids. The sludge is then thickened, or de-watered, to remove dissolved solids. The thickened sludge is burned at a temperature below 350 C to remove microorganisms. Elemental selenium is recovered in the form of an ash remaining after the sludge is burned.

When combined with a bioremediation process, the process provides for recycling or recovery of selenium from waste. The recovered selenium can be used as a resource for industrial applications.

### FIGURES

FIG. 1 is a schematic process flow diagram of a process for recovering selenium from wastewater.

FIG. 2 is a TGA analysis of elemental selenium and sludge microorganisms.

### DETAILED DESCRIPTION

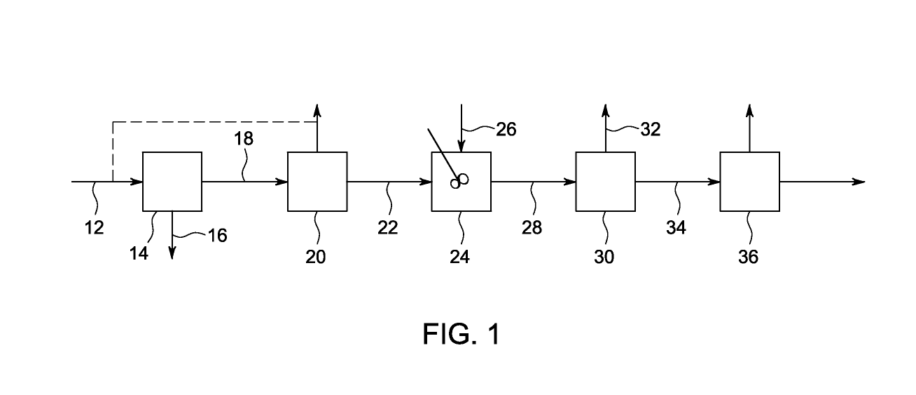

FIG. 1 shows a process 10 for recovering selenium. A feed flow 12 of wastewater containing selenium enters a bioreactor 14. For example, the feed flow 12 may be flue gas desulphurization blowdown water from a coal fired power plant. In the bioreactor 14, microorganisms convert soluble forms of selenium into insoluble elemental selenium. The bioreactor 14 may be an ABMet™ reactor available from GE Water and Process Technologies, a business within the General Electric Company. In this form of bioreactor 14, water to be treated flows through a fixed media bed that supports the microorganisms. The elemental selenium is retained as particles with biomass in the bioreactor 14. Treated water 16 flows out of the bioreactor 14, preferably with a selenium concentration reduced to below discharge limits. The bioreactor 14 is periodically flushed producing sludge 18, which contains biomass, elemental selenium and suspended solids that were present in the feed flow 12. Other bioremediation processes may also produce an effluent or sludge containing selenium. For example, selenium may be removed from wastewater in a membrane bioreactor containing a suspended growth of selenium reducing organisms. Elemental selenium is discharged in a sludge drawn from the bottom of a process tank or a separate membrane vessel.

The sludge 18 is sent to sludge thickening device 20 to produce a thickened sludge 22. The sludge thickening device 20 may be, for example, a centrifuge, filter press or a belt thickener. Excess water 24 released from the sludge 24 may be sent to a separate wastewater treatment plant or recycled to a point upstream of the bioreactor 14. The thickened sludge 22 may contain 10-30 wt % solids. The solids comprise cells of microorganisms released from the bioreactor 14, other suspended solids that were present in the feed water 12 to the bioreactor 14 and are still retained in the thickened sludge 22, and elemental selenium that has been reduced by the microorganisms. In one sample of a thickened sludge taken from an ABMet reactor treating flue gas desulphurization blowdown water from a coal-fired power plant, the solids in the thickened sludge 22 were composed of about 51% microorganism cells, about 48% other suspended solids, and a small percentage, about 1%, of selenium. A trace amount, less than 0.1%, of nickel was also present. The other suspended solids were primarily minerals such as gypsum particles, fly ash and limestone particles.

The thickened sludge 22 cannot be disposed as non-hazardous waste due to its high selenium concentration. In the USA, the thickened sludge 22 would have to be put through the Toxicity Characteristic Leaching Procedure (TCLP) to determine how the thickened sludge 22 must be handled. If the TCLP result is over 1.0 mg/L, which is likely, the thickened sludge 22 must at least be stored in a hazardous waste landfill area. If the TCLP result if over 5.7 mg/L, which is possible, then the thickened sludge 22 must be sent to a waste management company at great expense. In the process 10, however, the thickened sludge 22 is further treated in a recovery process to remove at least some of the remaining selenium, preferably such that any remaining sludge to be discharged has a TCLP of 1 mg/L or less.

In a first part of the recovery process, the thickened sludge 22 is sent to a mixing tank 24. In the mixing tank 24, an acid 26 is added to dissolve at least some of the non-cellular or mineral suspended solids. The mixing tank 24 may be maintained at ambient or room temperature, for example a temperature below 40 C or below 30 C. The acid 26 is preferably not an oxide. For example, the acid 26 may be hydrochloric acid (HCl). The mixing tank 24 is preferably stirred to enhance the reaction.

A partially dissolved sludge 28 flows from the mixing tank 24 to a solid-liquid physical separation device 30. The separation device 30 may be, for example, a centrifuge. A liquid portion 30 is removed leaving a further thickened sludge 34 in which the proportion of solids, particularly non-cellular and mineral solids, has been reduced.

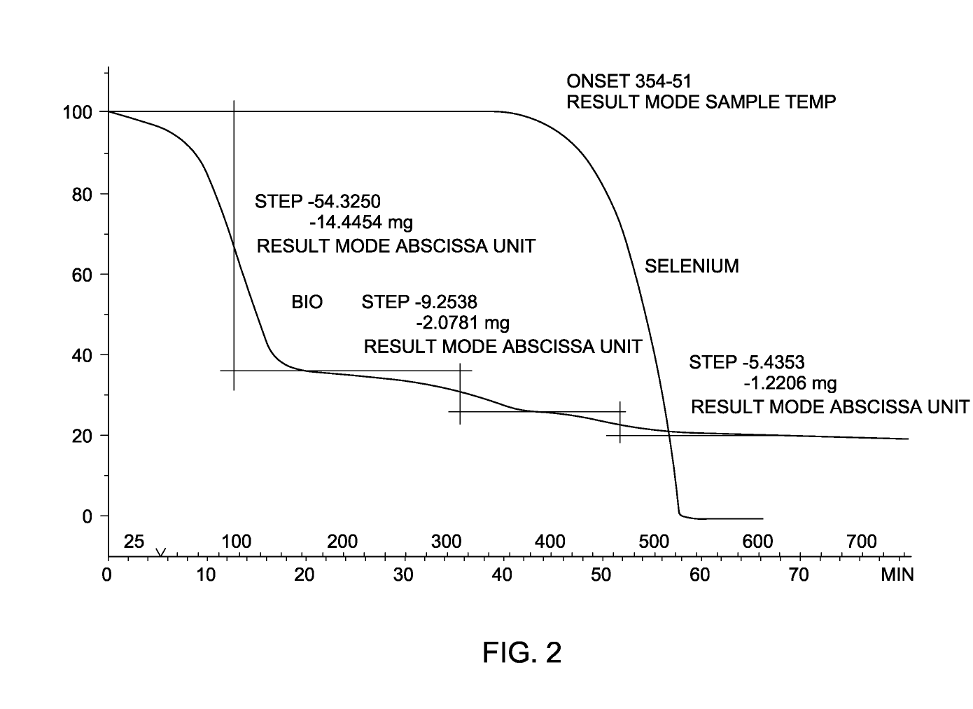

The further thickened sludge 34 is then treated further to remove the microorganisms. In the process 10, the further thickened sludge 34 is sent to a furnace 36 and burned, preferably at a temperature low enough to substantially prevent oxidation of the selenium. Referring to the TGA analysis of FIG. 2, selenium is oxidized at a temperature of about 350 C while a significant portion of the biomass in the sludge can be burned at about 200 or 250 C. Accordingly, burning the sludge at a temperature of, for example, between 250 C and 325 C removes biomass generally without oxidizing the selenium.

In an experiment, a sample of ABMet sludge as described above was treated with hydrochloric acid, further thickened in a centrifuge and then burned at 300 C. The weights of the solids in the sample are given in Table 2 below. As shown in the table, most of the sludge was burned away but most (over 70%) of the selenium was retained.

TABLE 2
Experimental results

| | weight of | |
|---|---|---|
| | all solids | Weight of selenium |
| | sample (g) | in sample (ug) |
| Further | 0.6919 | 1834.9188 |
| thickened | | |
| sludge | | |
| sludge after | 0.3352 | 1324.04 |
| burning at | | |
| 300 C. | | |
| weight lost % | 52 | 28 |

1. A process for recovering selenium from bioreactor sludge, the sludge comprising elemental selenium, microorganisms capable of reducing soluble forms of selenium and other solids, the process comprising steps of,
a) dissolving most of the other solids in the sludge;
b) removing water from the sludge; and,
c) burning the sludge at a temperature below 350 C.

2. The process of claim 1 wherein step a) comprises mixing an acid into the sludge.

3. The process of claim 2 wherein the acid is not an oxide.

4. The process of claim 3 wherein the sludge is maintained at a temperature of 40 C or below during step a).

5. The process of claim 1 wherein step b) comprises passing the sludge through a sludge thickening device.

6. The process of claim 1 wherein the sludge is burned at a temperature of between 250 C and 325 C.

7. A process for treating flue gas desulphurization blow down water comprising the steps of,
a) treating the wastewater in a bioreactor containing selenium reducing microorganisms;
b) withdrawing a sludge comprising particles of elemental selenium, microorganisms and mineral solids from the reactor;
c) dissolving most of the mineral solids;
d) removing water containing dissolved minerals from the sludge; and,
e) burning the sludge at a temperature below 350 C.

8. The process of claim 7 wherein step a) comprises mixing an acid into the sludge.

9. The process of claim 8 wherein the acid is not an oxide.

10. The process of claim 9 wherein the sludge is maintained at a temperature of 40 C or below during step a).

11. The process of claim 7 wherein step b) comprises passing the sludge through a sludge thickening device.

12. The process of claim 7 wherein the sludge is burned at a temperature of between 250 C and 325 C.

13. The process of claim 7 wherein step a) comprises flowing the wastewater through a fixed media bed and step b) comprises flushing or backwashing the media bed.
